(19) United States
(12) Patent Application Publication
(10) Pub. No.: US 2016/0216581 A1
(43) Pub. Date: Jul. 28, 2016

(54) LIQUID CRYSTAL DISPLAY

(71) Applicant: Samsung Display CO., Ltd., Yongin-si (KR)

(72) Inventors: Dan Bi YANG, Gunpo-si (KR); Min-Joo HAN, Seoul (KR); Ji Phyo HONG, Pyeongtaek-si (KR); Ki Chul SHIN, Seongnam-si (KR); Jae Hoon JUNG, Anyang-si (KR)

(21) Appl. No.: 14/957,260

(22) Filed: Dec. 2, 2015

(30) Foreign Application Priority Data
Jan. 22, 2015 (KR) 10-2015-0010586

(51) Int. Cl. G02F 1/1343; G02F 1/1333

(52) U.S. Cl. CPC G02F 1/134336; G02F 1/133345; G02F 2001/134345

(57) ABSTRACT

An exemplary embodiment of the present invention provides a liquid crystal display including a first substrate, a gate line formed on the first substrate, an insulating layer formed on the gate line, and a pixel electrode which is formed on the insulating layer and includes a first subpixel electrode and a second subpixel electrode in which the pixel electrode is divided into three sub regions, the first subpixel electrode is formed in a first sub region and the second subpixel electrode is formed in a third sub region, and both the first subpixel electrode and the second subpixel electrode are formed in a second sub region.

### CLAIM OF PRIORITY

This application claims the priority to and all the benefits accruing under 35 U.S.C. §119 of Korean Patent Application No. 10-2015-0010586 filed in the Korean Intellectual Property Office (KIPO) on Jan. 22, 2015, the entire contents of which are incorporated herein by reference.

### BACKGROUND OF INVENTION

1. Field of Disclosure

The present invention relates to a liquid crystal display.

2. Description of the Related Art

A liquid crystal display is one of the flat panel displays which are most widely used in recent years and includes two display panels in which a field generating electrode such as a pixel electrode and a common electrode is formed and a liquid crystal layer interposed between the display panels.

A voltage is applied to the field generating electrode to generate an electric field in the liquid crystal layer and an orientation of liquid crystal molecules of the liquid crystal layer is determined therethrough and polarization of incident light is controlled to display an image.

The liquid crystal display includes a switching element which is connected to each pixel electrode and a plurality of signal lines, such as a gate line and a data line, which control the switching element to apply a voltage to the pixel electrode.

Among the liquid crystal displays, a vertically aligned (VA) mode liquid crystal display in which a major axis of the liquid crystal molecule is arranged to be vertical to upper and lower displays in a state where no electric field is applied is getting the spotlight because it has a high contrast ratio and easily achieves a wide reference viewing angle. Here, the reference viewing angle refers to a viewing angle having a contrast ratio of 1:10 or a luminance inversion critical angle between gray scales.

In the case of such a liquid crystal display, a method which divides a pixel into two subpixels and applies different voltages to the two subpixels to vary transmittance has been suggested in order to make side visibility be close to front visibility.

However, when the side visibility is close to the front visibility dividing one pixel into two subpixels and varying transmittance as described above, the luminance is increased from a low gray scale to a high gray scale so that it is difficult to represent the gray scale at a side, thereby causing an image quality to be deteriorated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a display device which precisely represents a gray scale in a low gray scale region while making side visibility be close to front visibility.

An exemplary embodiment of the present invention provides a liquid crystal display including a first substrate, a gate line formed on the first substrate, an insulating layer formed on the gate line and a pixel electrode which is formed on the insulating layer and includes a first subpixel electrode and a second subpixel electrode in which the pixel electrode is divided into three sub regions, the first subpixel electrode is formed in a first sub region and the second subpixel electrode is formed in a third sub region, and both the first subpixel electrode and the second subpixel electrode are formed in a second sub region.

The first subpixel electrode may include a vertical stem portion, a plurality of horizontal stem portions extending from the vertical stem portion and a first part, a second part, and a third part which are defined by the horizontal stem portions and the second subpixel electrode may include a vertical stem portion, a plurality of horizontal stem portions extending from the vertical stem portion, and a first part, a second part, and a third part which are defined by the horizontal stem portions.

The first part of the first subpixel electrode may include a horizontal stem portion disposed at a center and minute branches extending from the horizontal stem portion in both diagonal directions.

The second part of the first subpixel electrode may include horizontal stem portions formed at an upper portion and a lower portion and minute branches extending from the horizontal stem portion to the center of the second part and an interval of minute branches formed in the second part may be larger than an interval of minute branches formed in the first part of the first subpixel electrode.

The third part of the first subpixel electrode may include a horizontal stem portion disposed at a center and minute branches extending from the horizontal stem portion in both diagonal directions and an interval of formed minute branches may be larger than an interval of minute branches formed in the first part of the first subpixel electrode.

The first part of the second subpixel electrode may include a horizontal stem portion disposed at a center and minute branches extending from the horizontal stem portion in both diagonal directions.

The second part of the second subpixel electrode may include horizontal stem portions formed at an upper portion and a lower portion and minute branches extending from the horizontal stem portion to the center of the second part and an interval of minute branches formed in the second part may be larger than an interval of minute branches formed in the first part of the first subpixel electrode.

The third part of the second subpixel electrode may include a horizontal stem portion disposed at a center and minute branches extending from the horizontal stem portion in both diagonal directions and an interval of formed minute branches is larger than an interval of minute branches formed in the first part of the second subpixel electrode.

The first part of the first subpixel electrode may configure the first sub region, the first part of the second subpixel electrode may configure the third sub region, the second part of the first subpixel electrode, and the third part of the second subpixel electrode may share a space and are alternately formed to configure the second sub region, and the third part of the first subpixel electrode and the second part of the second subpixel electrode may share a space and are alternately formed to configure the second sub region.

The first subpixel electrode and the second subpixel electrode may be applied with different voltages and a voltage which is applied to the first subpixel electrode may be higher than a voltage which is applied to the second subpixel electrode.

The number of minute branches of the second part of the first subpixel electrode may be different from the number of minute branches of the third part of the second subpixel electrode.

The number of minute branches of the third part of the first subpixel electrode may be different from the number of minute branches of the second part of the second subpixel electrode.

The highest electric field may be formed in the first sub region, the lowest electric field may be formed in the third sub region, and an electric field having an intermediate level between the electric field of the first sub region and the electric field of the third sub region may be formed in the second sub region.

Each of the first subpixel electrode and the second subpixel electrode may include a vertical stem portion, a plurality of horizontal stem portions extending from the vertical stem portion, and a plurality of minute branches extending from the plurality of horizontal stem portions and the vertical stem portion of the first subpixel electrode and the vertical stem portion of the second subpixel electrode are formed to be opposite to each other along both edges of one pixel area.

The plurality of minute branches may be formed at +40 degrees to +50 degrees or −40 degrees to −50 degrees with respect to the horizontal stem portion.

In the second sub region, one minute branch of the second subpixel electrode may be formed to be alternated with two minute branches of the first subpixel electrode.

In the second sub region, two minute branches of the second subpixel electrode may be formed to be alternated with one minute branch of the first subpixel electrode.

As described above, in the liquid crystal display according to the exemplary embodiment of the present invention, the first subpixel electrode and the second subpixel electrode are alternately formed in a partial region so that three different electric fields are formed in the pixel electrode, thereby improving visibility.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a layout view for an example of one pixel of a liquid crystal display according to an exemplary embodiment of the present invention.

FIG. 2 is a cross-sectional view of the liquid crystal display of FIG. 1 taken along the line III-III.

FIG. 3 illustrates a first subpixel electrode of a liquid crystal display according to an exemplary embodiment of the present invention.

FIG. 4 illustrates a second subpixel electrode of a liquid crystal display according to an exemplary embodiment of the present invention.

FIG. 5 illustrates a pixel electrode of a liquid crystal display according to an exemplary embodiment of the present invention.

FIGS. 6 and 7 illustrate a pixel electrode of a liquid crystal display according to another exemplary embodiment of the present invention.

FIG. 8 illustrates a cross-Section of a second region of a display device according to an exemplary embodiment of the present invention.

FIG. 9 illustrates a voltage of each region of a display device according to an exemplary embodiment of the present invention.

FIG. 10 illustrates a V-T curved line when a voltage is applied in each region in a display device according to an exemplary embodiment of the present invention.

FIG. 11 is a top plan view of one pixel according to a comparative example of the present invention.

FIG. 12 is a cross-sectional view taken along the line III-III of FIG. 11.

FIG. 13 is a top plan view of a basic pixel according to a comparative example of the present invention.

FIG. 14 is a top plan view of a first sub region electrode of a first subpixel electrode according to a comparative example of the present invention.

FIG. 15 is a top plan view of a second sub region electrode of a first subpixel electrode and a second subpixel electrode according to an exemplary embodiment of the present invention.

FIG. 16 illustrates an electric field formed in a second part of a liquid crystal display according to a comparative example of the present invention.

FIGS. 17 to 21 are equivalent circuit diagrams of one pixel of a liquid crystal display according to an exemplary embodiment of the present invention.

### DETAILED DESCRIPTION OF INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can he directly on the other element or intervening elements may also be present. In contrast, when an element is referred to as being “directly on” another element, there are no intervening elements present.

Now, a liquid crystal display according to an exemplary embodiment of the present invention will he described in detail with reference to the drawings.

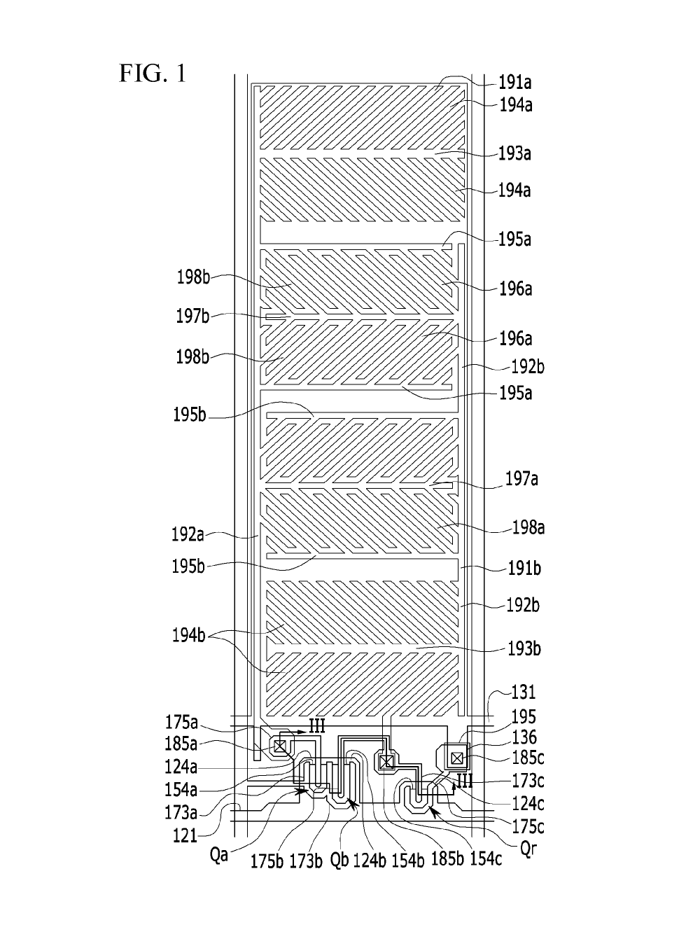

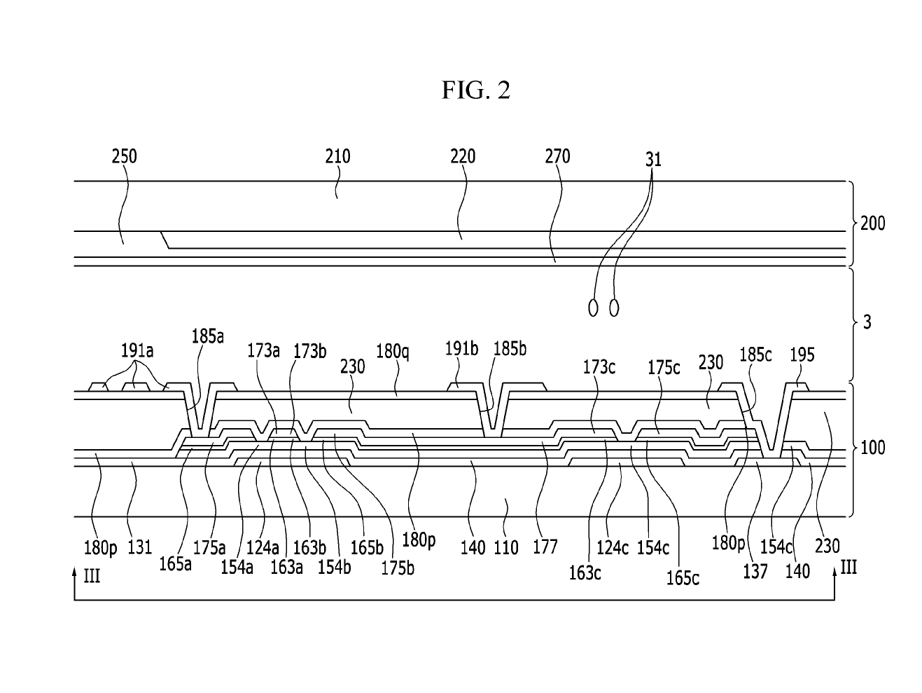

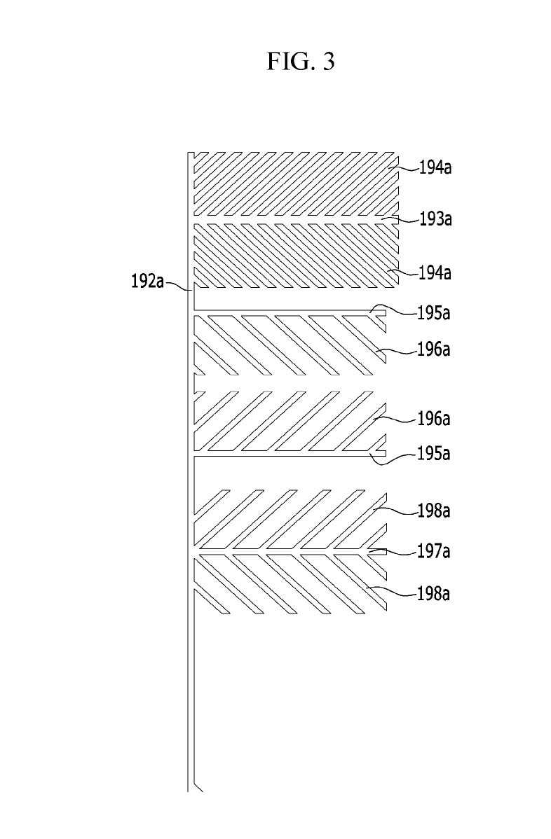

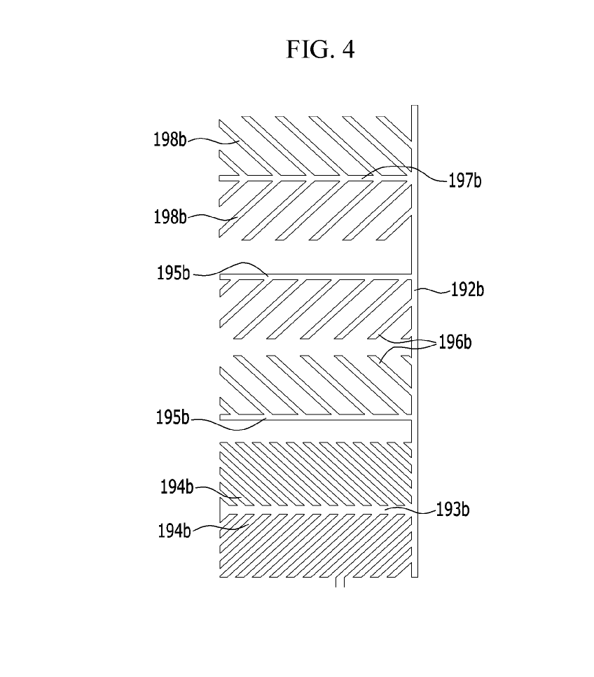

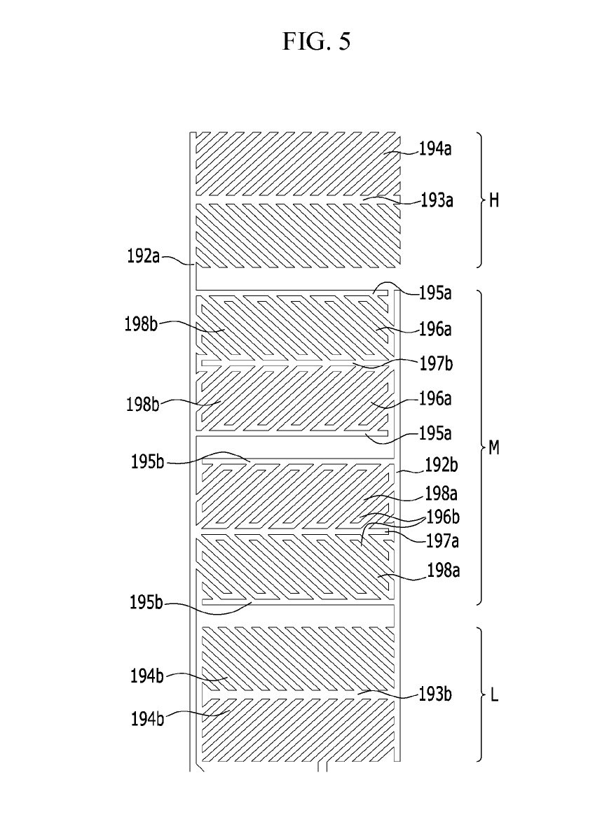

A structure of a liquid crystal display according to an exemplary embodiment of the present invention will be described in brief with reference to FIGS. 1 to 5. FIG. 1 is a layout view for an example of one pixel of a liquid crystal display according to an exemplary embodiment of the present invention and FIG. 2 is a cross-sectional view of the liquid crystal display of FIG. 1 taken along the line III-III. FIG. 3 illustrates a first subpixel electrode of a liquid crystal display according to an exemplary embodiment of the present invention and FIG. 4 illustrates a second subpixel electrode of a liquid crystal display according to an exemplary embodiment of the present invention. FIG. 5 illustrates a pixel electrode of a liquid crystal display according to an exemplary embodiment of the present invention.

First, referring to FIGS. 1 and 2, a liquid crystal display according to the present exemplary embodiment includes a lower panel 100 and a upper panel 200 which are opposite to each other, a liquid crystal layer 3 interposed between two display panels 100 and 200, and a pair of polarizers (not illustrated) which are attached on outer surfaces of the display panels 100 and 200.

First, the lower panel 100 will be described.

A gate conductor including a gate line 121 and a voltage dividing reference voltage line 131 is formed on an insulation substrate 110 which is formed of transparent glass or plastic.

The gate line 121 includes a first gate electrode 124a, a second gate electrode 124b, a third gate electrode 124c, and a wide end portion (not illustrated) for connection with other layer or an external driving circuit.

The voltage dividing reference voltage line 131 includes first storage electrodes 135 and 136 and a reference electrode 137. Second storage electrodes 138 and 139 are disposed to overlap a second subpixel electrode 191b but are not connected to the voltage dividing reference voltage line 131.

A gate insulating layer 140 is formed on the gate line 121 and the voltage dividing reference voltage line 131.

A first semiconductor 154a, a second semiconductor 154b, and a third semiconductor 154c are formed on the gate insulating layer 140.

A plurality of ohmic contacts 163a, 165a, 163b, 165b, 163c, and 165c is formed on the semiconductors 154a, 154b, and 154c.

A plurality of data lines 171 including a first source electrode 173a and a second source electrode 173b and a data conductor including a first drain electrode 175a, a second drain electrode 175b, a third source electrode 173a, and a third drain electrode 175c are formed on the ohmic contacts 163a, 165a, 163b, 165b, 163c, 165c and the gate insulating layer 140.

The data conductor and the semiconductors and the ohmic contacts which are formed below the data conductor may be simultaneously formed using one mask.

The data line 171 includes a wide end portion (not illustrated) for connection with other layer or an external driving circuit.

The first gate electrode 124a, the first source electrode 173a, and the first drain electrode 175a form a first thin film transistor (TFT) Qa together with a first semiconductor island 154a and a channel of the thin film transistor is formed in the semiconductor 154a between the first source electrode 173a and the first drain electrode 175a. Similarly, the second gate electrode 124b, the second source electrode 173b, and the second drain electrode 175b form a second thin film transistor Qb together with a second semiconductor island 154b and a channel is formed in the semiconductor 154b between the second source electrode 173b and the second drain electrode 175b. The third gate electrode 124c, the third source electrode 173c, and the third drain electrode 175c form a third thin film transistor Qc together with a third semiconductor island 154c and a channel is formed in the semiconductor 154c between the third source electrode 173c and the third drain electrode 175c.

The second drain electrode 175b is connected to the third source electrode 173c and has an expansion 177 which widely expands.

A first passivation layer 180p is formed on the data conductors 171, 173c, 175a, 175b, and 175c and exposed portions of the semiconductors 154a, 154b, and 154c. The first passivation layer 180p may include an inorganic insulating layer such as silicon nitride or silicon oxide. The first passivation layer 180p may prevent a pigment of a color filter 230 from inflowing into the exposed portions of the semiconductors 154a, 154b, and 154c.

A color filter 230 is formed on the first passivation layer 180p. The color filter 230 extends in a vertical direction along two adjacent data lines. A first light blocking member 220 is disposed on the first passivation layer 180p, an edge of the color filter 230, and the data line 171.

However, the color filter 230 may be formed on the upper panel 200 rather than the lower panel 100.

A second passivation layer 180q is formed on the color filter 230.

The second passivation layer 180q may include an inorganic insulating layer such as silicon nitride or silicon oxide. The second passivation layer 180q prevents the color filter 230 from being loosen and suppresses the contamination of the liquid crystal layer 3 by an organic material such as a solvent which inflows from the color filter 230, thereby preventing a problem such as an image lag caused when a screen is driven.

In the first passivation layer 180p and the second passivation layer 180q, a first contact hole 185a and a second contact hole 185b are formed to expose the first drain electrode 175a and the second drain electrode 175b.

A third contact hole 185c is formed in the first passivation layer 180p, the second passivation layer 180q, and the gate insulating layer 140 to expose a part of the reference electrode 137 and a part of the third drain electrode 175c and the third contact hole 185c is covered by a connecting member 195. The connecting member 195 electrically connects the reference electrode 137 and the third drain electrode 175c which are exposed through the third contact hole 185c.

A plurality of pixel electrodes 191 is formed on the second passivation layer 180q. Each pixel electrode 191 includes a first subpixel electrode 191a and a second subpixel electrode 191b. The pixel electrode 191 may be formed of a transparent material such as ITO and IZO. The pixel electrode 191 may be formed of a transparent conductive material such as ITO or IZO or a reflective metal such as aluminum, silver, chromium, or an alloy thereof.

The pixel electrode 191 includes a first subpixel electrode 191a and a second subpixel electrode 191b which are separated from each other.

The first subpixel electrode 191a and the second subpixel electrode 191b include vertical stem portions which are parallel to the data lines. That is, the first subpixel electrode includes a vertical stem portion which is parallel to one data line and the second subpixel electrode includes a vertical stem portion which is parallel to another data line. Specific shapes of the first subpixel electrode 191a and second subpixel electrode 191b will be described below.

The first subpixel electrode 191a and the second subpixel electrode 191b are physically and electrically connected to the first drain electrode 175a and the second drain electrode 175b through the first contact hole 185a and the second contact hole 185b, respectively and are applied with data voltages from the first drain electrode 175a and the second drain electrode 175b. In this case, a part of the data voltage which is applied to the second drain electrode 175b is divided by the third source electrode 173c so that the voltage which is applied to the first subpixel electrode 191a is higher than the voltage which is applied to the second subpixel electrode 191b.

The first subpixel electrode 191a and the second subpixel electrode 191b to which the data voltages are applied generate an electric field together with the common electrode 270 of the upper panel 200 to determine a direction of the liquid crystal molecules of the liquid crystal layer 3 between two electrodes 191 and 270. The luminance of light which passes through the liquid crystal layer 3 varies depending on the direction of the liquid crystal molecule determined as described above.

Now, the upper panel 200 will be described.

A black matrix 220 is formed on the insulation substrate 210. The black matrix is formed in the upper panel 200 so as to correspond to a region where the data line of the lower panel 100 is formed and a region where the transistors are formed.

An overcoat 250 is formed on the black matrix. The overcoat 250 may be omitted.

A common electrode 270 is formed on the overcoat 250. An upper alignment layer (not illustrated) is formed on the common electrode 270. The upper alignment layer may be a vertical alignment layer.

The liquid crystal layer 3 has negative dielectric anisotropy and liquid crystal molecules of the liquid crystal layer 3 are aligned such that a major axis is vertical to surfaces of the two display panels 100 and 200 in a state where no electric field is formed.

Further, even though not illustrated, a lower polarizer is provided below the lower panel and an upper polarizer is provided on the upper panel. Such polarizers polarizes light which is incident from a backlight unit (not illustrated) in a predetermined direction to inflow the light into the liquid crystal display and polarizes the light which passes through the liquid crystal display in a predetermined direction again to emit the light to the outside.

Now, a shape of the pixel electrode of the liquid crystal display according to the exemplary embodiment of the present invention will be described with reference to FIGS. 3 to 5.

FIG. 3 illustrates a first subpixel electrode of a liquid crystal display according to an exemplary embodiment of the present invention and FIG. 4 illustrates a second subpixel electrode of a liquid crystal display according to an exemplary embodiment of the present invention. FIG. 5 illustrates a pixel electrode of a liquid crystal display according to an exemplary embodiment of the present invention.

Referring to FIG. 3, a first subpixel electrode 191a according to the exemplary embodiment of the present invention includes a vertical stem portion 192a which vertically extends, a plurality of horizontal stem portions 193a, 195a, and 197a which extends from the vertical stem portion 192a, and minute branches 194a, 196a, and 198a which extend from the horizontal stem portions.

As illustrated in FIG. 3, the first subpixel electrode includes three parts having different shapes. Parts of the first subpixel electrode are named a first part H1, a second part H2, and a third part H3 from the top and each part will be described.

First, the first part H1 includes a horizontal stem portion 193a which is disposed at a center of the first part and minute branches 194a which extend from the horizontal stem portion 193a in both diagonal directions.

The minute branches 194a are formed in diagonal directions which start from the horizontal stem portion 193a to be far from the vertical stem portion. The minute branches 194a may be symmetrical to each other in both directions with respect to the horizontal stem portion 193a. That is, when an angle of the minute branch 194a which is formed above the horizontal stem portion 193a is +45 degrees, an angle of the minute branch 194a which is formed below the horizontal stem portion 193a may be −45 degrees.

An angle at which the minute branches are formed may be +40 degrees to 50 degrees and −40 degrees to 50 degrees.

Next, the second part H2 will be described. Horizontal branches 195a are formed in an upper region and a lower region of the second part. In the horizontal stem portion 195a which is formed in the upper region of the second part, minute branches 196a are formed in a downward diagonal direction which is far from the vertical stem portion 192a with respect to the horizontal stem portion 195a. That is, in the horizontal stem portion 195a which is formed in the upper region of the second part, the minute branch 196 may be formed in −45 degree direction. The minute branch 196a may be formed at −40 degrees to −50 degrees with respect to the upper horizontal stem portion 195a.

In this case, an interval between the minute branches 196a formed here may be larger than an interval between minute branches 194a formed in the first part H1. That is, when an interval between the minute branches 194a formed in the first part H1 is n, an interval between minute branches 196a formed in the second part H2 may be 2n. In other words, when n minute branches are formed in the first part H1, n/2 minute branches may be formed in the second part H2.

The horizontal stem portion 195a is also disposed in the lower region of the second part H2. In the lower horizontal stem portion 195a, the minute branches 196a are formed in an upward diagonal direction which is far from the vertical stem portion 192a. That is, in the horizontal stem portion 195a which is formed in the lower region of the second part, the minute branch 196 may be formed in +45 degree direction. The minute branch 196a may be formed at +40 degrees to +50 degrees with respect to the upper horizontal stem portion 195a.

In this case, an interval between the minute branches 196a formed here may he larger than an interval between minute branches 194a formed in the first part H1. That is, when an interval between the minute branches 194a formed in the first part H1 is n, an interval between minute branches 196a formed in the second part H2 may be 2n. When n minute branches are formed in the first part H1, n/2 minute branches may be formed in the second part H2.

Next, the third part H3 will be described. Similarly to the first part H1, in the third part H3, a horizontal stem portion 197a is disposed at a center thereof.

That is, the third part H3 includes the horizontal stem portion 197a which is disposed at the center of the third part and minute branches 198a which extend from the horizontal stem portion 197a in both diagonal directions.

The minute branches 198a are formed in diagonal directions which start from the horizontal stem portion 197a to be far from the vertical stem portion. The minute branches 198a may be symmetrical to each other in both directions with respect to the horizontal stem portion 197a. That is, when an angle of the minute branch 198a which is formed above the horizontal stem portion 197a is +45 degrees, an angle of the minute branch 198a which is formed below the horizontal stem portion 197a may be −45 degrees.

An angle at which the minute branches are formed may be +40 degrees to 50 degrees and −40 degrees to 50 degrees.

In this case, an interval between the minute branches 198a formed here may be larger than an interval between minute branches 194a formed in the first part H1. That is, when an interval between the minute branches 194a formed in the first part H1 is n, an interval between minute branches 196a formed in the third part H3 may be 2n. When n minute branches are formed in the first part H1, n/2 minute branches may be formed in the third part H3.

Now, a shape of the second subpixel electrode of the exemplary embodiment of the present invention will be described with reference to FIG. 4. Referring to FIG. 4, a shape of the second subpixel electrode of the exemplary embodiment of the present invention is similar to a shape of the first subpixel electrode. However, as illustrated in FIG. 4, the vertical stem portion 192b of the second subpixel electrode is located to be opposite to the vertical stem portion 192a of the first subpixel electrode.

That is, in one pixel area, when the vertical stem portion 192a of the first subpixel electrode is located at the left, the vertical stem portion 192b of the second subpixel electrode is located at the right. In contrast, when the vertical stem portion 192a of the first subpixel electrode is located at the right, the vertical stem portion 192b of the second subpixel electrode is located at the left.

Referring to FIG. 4, the second subpixel electrode has three parts having different shapes. Parts of the second subpixel electrode are named as a first part L1, a second part L2, and a third part L3 and each part will be described.

Referring to FIGS. 3 and 4, the shape of the first part H1 of the first subpixel electrode is similar to the shape of the first part L1 of the second subpixel electrode. That is, when the first part H1 of the first subpixel electrode rotates at 180 degrees, the first part H1 is the same as the first part L1 of the second subpixel electrode. Since the shape of the first part L1 of the second subpixel electrode is the same as the shape of the first part H1 of the first subpixel electrode, description of the first part of the second subpixel electrode will be omitted.

As a whole, when the first subpixel electrode rotates in-plane at 180 degrees with respect to the center of the first subpixel electrode, the first subpixel electrode is the same as the second subpixel electrode.

Similarly, the shape of the second part H2 of the first subpixel electrode is the same as a shape of the second part L2 of the second subpixel electrode. Further, the shape of the third part H3 of the first subpixel electrode is the same as a shape of the third part L3 of the second subpixel electrode. Accordingly, specific description of the first part, the second part, and the third part of the second subpixel electrode will be omitted.

FIG. 5 illustrates a pixel electrode of a display device according to an exemplary embodiment of the present invention which includes both the first subpixel electrode and the second subpixel electrode.

Referring to FIG. 5, in the pixel electrode of the exemplary embodiment of the present invention, the first subpixel electrode and the second subpixel electrode share a partial region. That is, the pixel electrode is divided into a first region H, a second region M and a third region L.

As illustrated in FIG. 5, in the first region H, only the first part H1 of the first subpixel electrode is disposed. First, in the third region L, only the first part of the second subpixel electrode is disposed. That is, in the first region H and the third region L, the first subpixel electrode or the second subpixel electrode is located.

However, in the second region M of the pixel electrode, both the first subpixel electrode and the second subpixel electrode are formed.

Referring to FIG. 5, an area of the second region M is larger than that of the first region H and the third region L. The area of the second region M may be equal to a sum of the areas of the first region H and the third region L.

In the second region M, the second part H2 of the first subpixel electrode and the third part L3 of the second subpixel electrode are formed to share a space and the third part H3 of the first subpixel electrode and the second part L2 of the second subpixel electrode are formed to share a space.

As described above, the second part H2 of the first subpixel electrode includes two horizontal stem portions 195a and minute branches 196a which extend from the horizontal stem portion 195a.

Further, the third part L3 of the second subpixel electrode includes a horizontal stem portion 197b which is disposed at the center of the third part and minute branches 198b which extend from the horizontal stem portion 197b in both diagonal directions.

The minute branches 196a of the first subpixel electrode and the minute branches 198b of the second subpixel electrode are adjacent to each other one by one in the same region. Therefore, with respect to a virtual horizontal line, which traverses the second region M, the minute branches 196a of the first subpixel electrode and the minute branches 198b of the second subpixel electrode alternately meet one by one. When the first subpixel electrode and the second subpixel electrode are alternately formed as described above, in the region, an electric field generated in this region is different from the electric field of the first region or the third region, which will he described in detail below.

Similarly, the third part H3 of the first subpixel electrode and the second part L2 of the second subpixel electrode share the region.

That is, as described above, the second part L2 of the second subpixel electrode is configured by the two horizontal stem portions 195b and the minute branches 196b extending from the horizontal stem portions 195b.

Further, the third part H3 of the first subpixel electrode includes a horizontal stem portion 197a which is disposed at the center and minute branches 198a which extend from the horizontal stem portion 197a in both diagonal directions.

The minute branches 196b of the second subpixel electrode and the minute branches 198a of the first subpixel electrode are adjacent to each other one by one in the same region. That is, the horizontal stem portion 197a of the first subpixel electrode is disposed between the horizontal stem portions 195b of the second subpixel electrode and the minute branches 196b and 198a of individual electrodes are alternately disposed in a region between the horizontal stem portions.

An electric field generated in the second region is different from the electric field of the first region or the third region. A highest electric field is generated in the first region, a lowest electric field is generated in the third region, and a medium electric field is generated in the second region, which will be described below. Accordingly, a degree of lying liquid crystals varies in every region and thus the side visibility may be improved.

Referring to FIG. 5, directions of forming the minute branches in one pixel electrode are different from each other. That is, an overall shape of the minute branches in the first region H is an angle bracket shape of < which is directed to the right side and an overall shape of the minute branches in the second region M is an angle bracket shape of > which is directed to the left and an angle bracket shape of < which is directed to the right. Next, the shape of the minute branches in the third region L is an angle bracket shape of > which is directed to the left.

Accordingly, the directions of forming the minute branches in one pixel electrode are defined by the directions of the shapes of angle bracket of <, >, <, > which are arranged in a vertical direction.

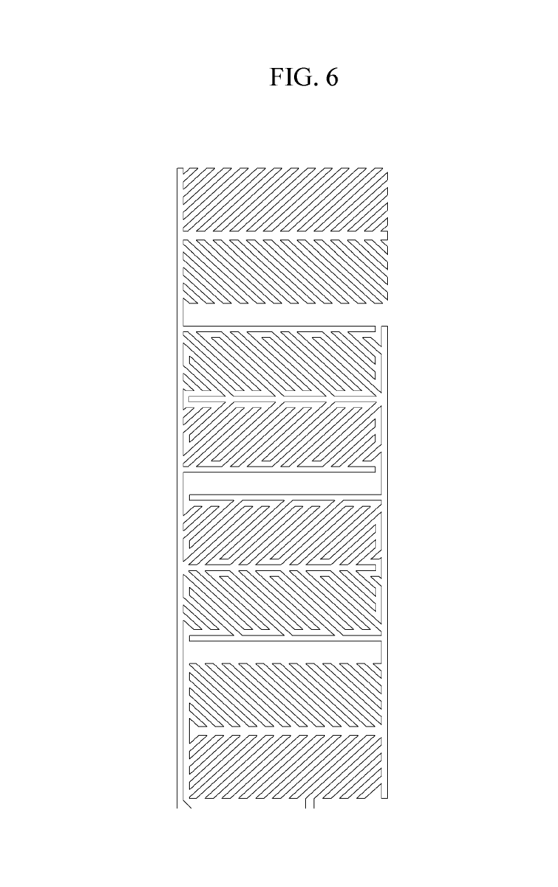

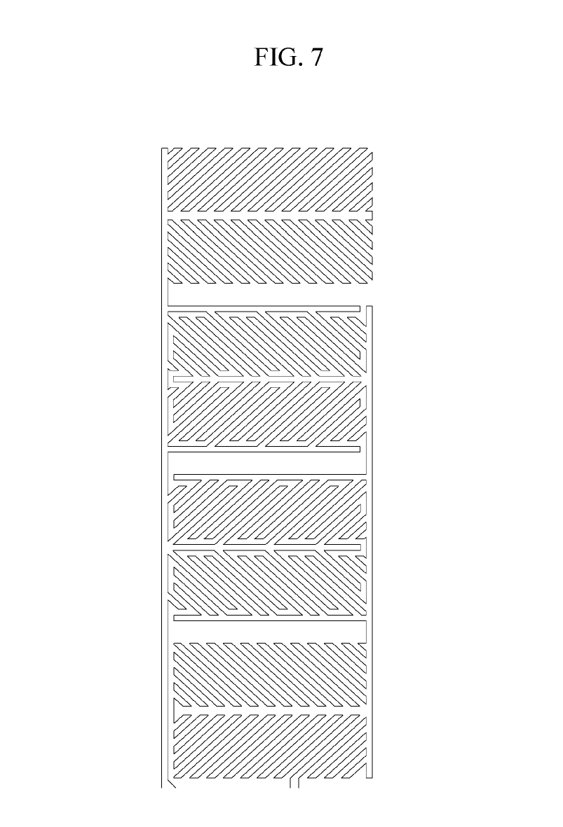

FIGS. 6 and 7 illustrate a pixel electrode of a liquid crystal display according to another exemplary embodiment of the present invention. A shape of the pixel electrode according to the exemplary embodiment of FIGS. 6 and 7 is substantially same as the shape of the pixel electrode according to the exemplary embodiment of FIG. 5. Specific description of the same constituent elements will be omitted.

However, referring to FIG. 6, a shape of the second region of the liquid crystal display according to the present exemplary embodiment is different from the shape of the second region of the display device of FIG. 5. That is, in FIG. 5, in the second region M, the minute branches of the first subpixel electrode and the minute branches of the second subpixel electrode are alternately formed with each other one by one.

However, in the case of the pixel electrode of FIG. 6, one minute branch of the second subpixel electrode is formed to be alternated with two minute branches of the first subpixel electrode.

That is, the number of minute branches of the first subpixel electrode is larger than the number of minute branches of the second subpixel electrode in the second region M.

This change will be applied only to the second region M, but there is no change in the first region H and the third region L where the minute branches of the first subpixel electrode and the minute branches of the second subpixel electrode are not alternately formed.

First, in the case of the pixel electrode according to an exemplary embodiment of FIG. 7, two minute branches of the second subpixel electrode are formed to be alternated with one minute branch of the first subpixel electrode. That is, in the second region M, the number of minute branches of the second subpixel electrode is larger than the number of minute branches of the first subpixel electrode.

As described above, the electric field which is generated in the second region may be adjusted by varying the number of minute branches of the first subpixel electrode and the number of minute branches of the second subpixel electrode in the second region M.

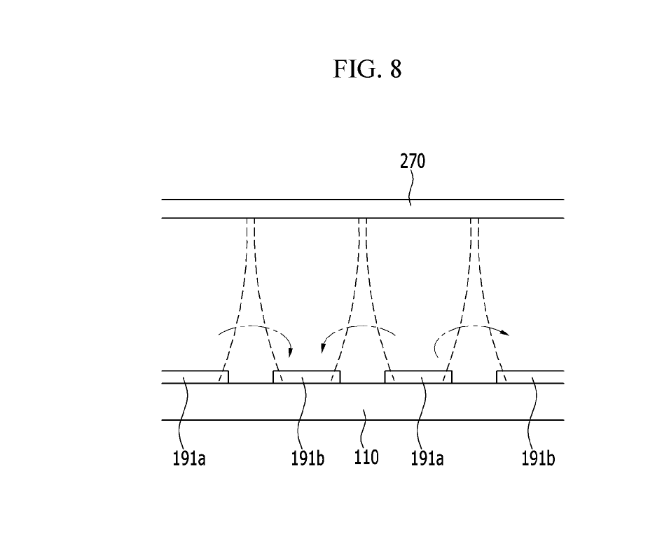

Now, an effect of another display device according to an exemplary embodiment of the present invention will be described with reference to FIGS. 8 to 11.

FIG. 8 illustrates a cross-section of a second region of a display device according to an exemplary embodiment of the present invention. Referring to FIG. 8, in the display device according to an exemplary embodiment of the present invention, minute branches 191a of a first subpixel electrode and minute branches 191b of a second subpixel electrode are alternately formed on a first substrate.

Further, a common electrode 270 is formed on the second substrate.

As illustrated in FIG. 1, the first subpixel electrode and the second subpixel electrode are connected to different transistors, respectively and different voltages may be applied to the first subpixel electrode and the second subpixel electrode depending on the connection pattern of the transistor.

That is, a second thin film transistor which is connected to the second subpixel electrode is connected to a third thin film transistor to divide a voltage so that a voltage which is applied to the first thin film transistor is higher than a voltage which is applied to the second thin film transistor.

Accordingly, as illustrated in FIG. 2, a vertical electric field is generated between the pixel electrodes 191a and 191b and the common electrode 270 and a horizontal electric field is generated between the first subpixel electrode 191a and the second subpixel electrode 191b due to the voltage difference.

Therefore, in the entire region of the pixel electrode, the electric field generated in the second region M is different from the electric field generated in the first region H and the third region L.

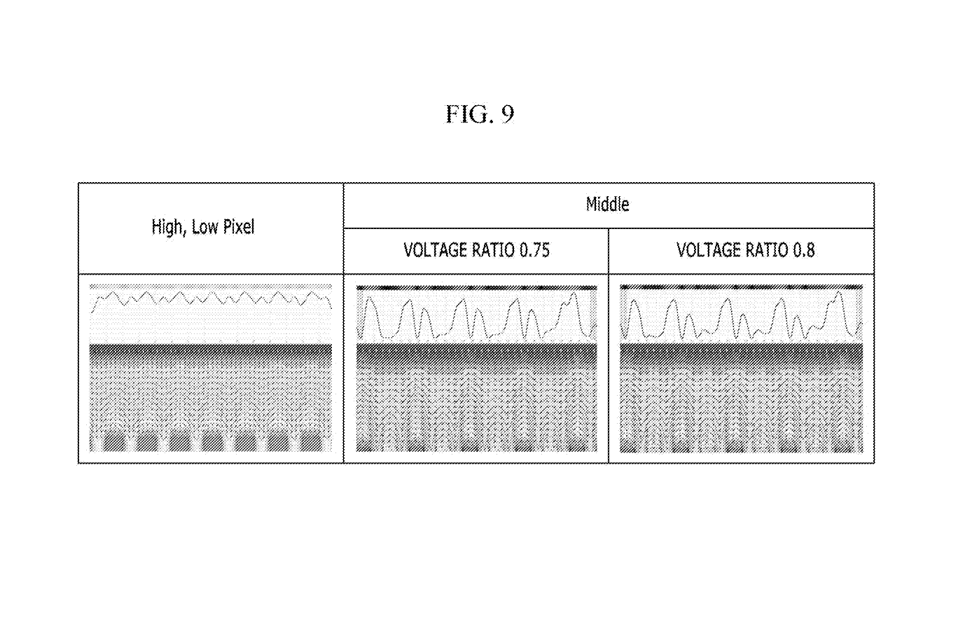

FIG. 9 illustrates a voltage in each region. Referring to FIG. 9, voltages in minute branches are similar in the first region (high) or the third region (low). However, referring to FIG. 9, the minute branch of the second region (middle) alternately shows a high voltage and a low voltage and an average voltage level of the second region is an intermediate level, of the first region and the third region.

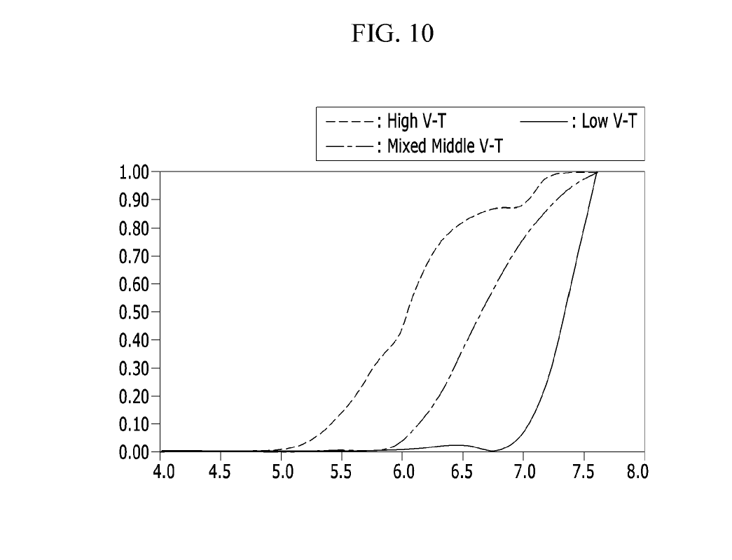

FIG. 10 illustrates a V-T curved line when a voltage is applied in each region. As illustrated in FIG. 10, V-T curved lines are different in every region in one pixel electrode of the liquid crystal display according to the exemplary embodiment of the present invention.

Referring to FIGS. 5 and 10, only a first subpixel electrode to which the highest voltage is applied is located in the first region H. Accordingly, as illustrated in FIG. 10, in the first region, transmittance of the liquid crystal for the same voltage is the highest (high V-T).

Further in the third region L, only a second subpixel electrode to which the lowest voltage is applied is located. Accordingly, as illustrated in FIG. 10, in the third region, transmittance of the liquid crystal for the same voltage is the lowest (low V-T).

Further, in the second region M, as described above, both the first subpixel electrode to which a high voltage is applied and the second subpixel electrode to which a relatively low voltage is applied are located. Therefore, a voltage generated in the second region M is intermediate between the voltages generated in the first region H and the third region L. Referring to FIG. 10, it is understood that the transmittance (mixed middle V-T) of the liquid crystal for the same voltage in the second region is intermediate between the voltages of the first region and the third region.

That is as described above, in the liquid crystal display according to the exemplary embodiment of the present invention, there are three regions in which voltage ratios are different in one pixel electrode. That is, the degree of lying the liquid crystal varies in every region and a viewer equally watches a head, a body, and a tail of the liquid crystal from the front and the side so that the visibility may be improved.

That is, in order to improve the visibility, in the related art, the pixel region is divided into a first subpixel electrode region and a second subpixel electrode region and different voltages are applied to each of the subpixel electrodes.

However, in the case of the display device according to the exemplary embodiment of the present invention, the pixel area is divided into three regions while using the same transistor structure and forming a part of the first subpixel electrode and a part of the second subpixel electrode to share the region.

Therefore, as compared with the case where the pixel area is divided into two regions, the visibility may be further improved.

Further in the case of the display device according to another comparative example according to an exemplary embodiment of the present invention, in order to divide the pixel area into three regions, a part of the first subpixel electrode is formed on a different layer to vertically overlap the second subpixel electrode with the insulating layer therebetween. However, in the case of the display device according to the comparative example of the present invention, since the part of the first subpixel electrode is separately formed on another layer during the forming step of the pixel electrode, the process step may be complex.

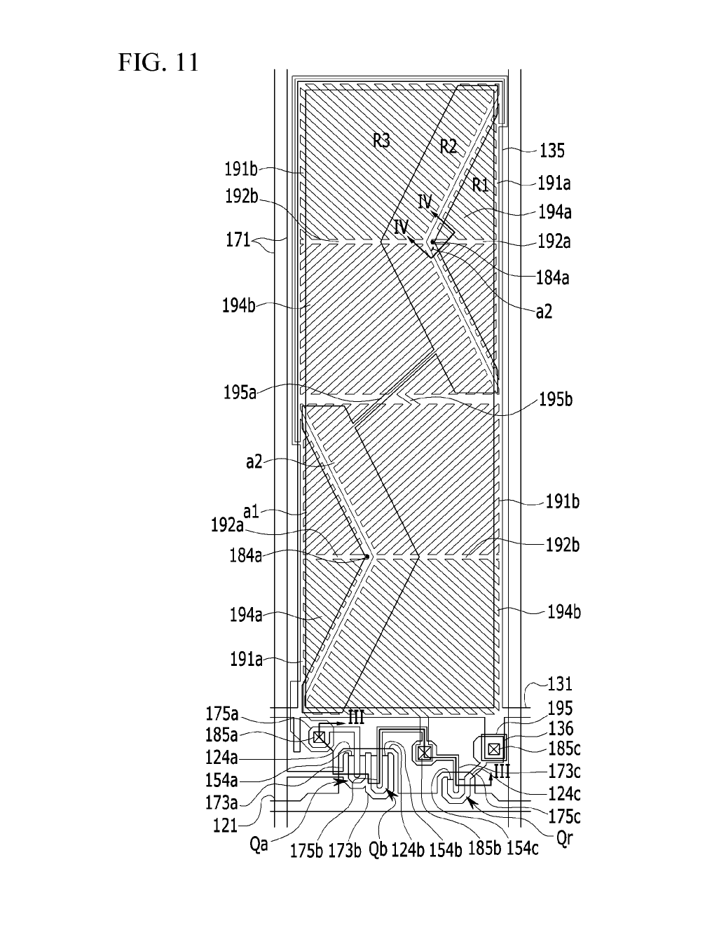

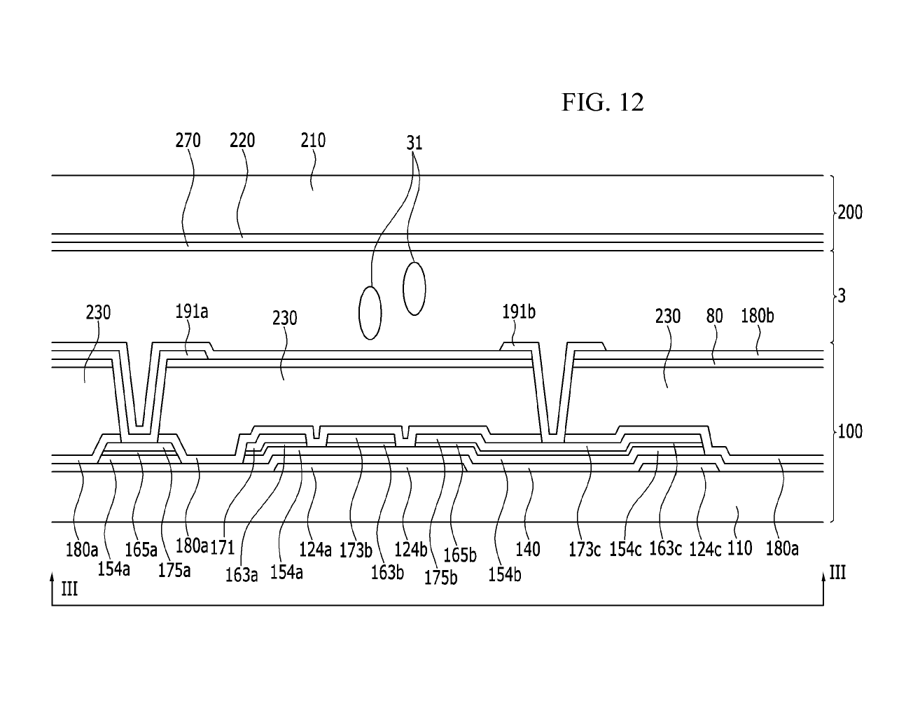

FIGS. 11 to 16 illustrate a liquid crystal display according to a comparative example of the present invention. FIG. 11 is a top plan view of one pixel according to a comparative example of the present invention and FIG. 12 is a cross-sectional view taken along the line III-III of FIG. 11.

Similar and same parts of the exemplary embodiment of the present invention will not be described. However, referring to FIGS. 11 and 12, a first sub region electrode a1 is disposed on an overcoat 80 and an insulating layer 180b is located on the first sub region electrode a1.

A second sub region electrode a2 and a second subpixel electrode 191b of a first subpixel electrode 191a are disposed on the insulating layer 180b. In this case, the first sub region electrode a1 and the second sub region electrode a2 of the first subpixel electrode 191a may be connected to each other through a contact hole 184a.

The second sub region electrode a2 of the first subpixel electrode 191a and the second subpixel electrode 191b are applied with data voltages from a first drain electrode 175a and a second drain electrode 175b through a first contact hole 185a and a second contact hole 185b, respectively. The first sub region electrode a1 and the second sub region electrode a2 are electrically connected to each other through the contact hole 184a so that the first sub region electrode a1 receives the data voltage (a first voltage) which is applied to the second sub region electrode a2.

More specifically, one pixel area of the display device according to the comparative example includes the first subpixel electrode 191a, the second subpixel electrode 191b, and a common electrode 270, which includes an upper unit electrode unit electrode UP and a lower unit electrode DP which are distinguished by the location and also includes a first pan R1, a second part R2, and a third part R3 which are distinguished by a level of applied electric field.

The first sub region electrodes a1 of the first subpixel electrode 191a which are disposed in the upper unit electrode UP and the lower unit electrode DP are disposed in a different layer from the second sub region electrode a2 of the first subpixel electrode 191a and for example, may be disposed in a different layer from the second sub region electrode a2 with an insulating layer therebetween.

The first sub region electrode at may further include a first connecting unit 195a which connects the first sub region electrodes at which are disposed in the upper unit electrode UP and the lower unit electrode DP and a shape of the first connecting unit 195a is not specifically limited.

The first sub region electrode a1 is electrically connected to the second sub region electrode a2 which is connected to a first thin film transistor so as to be applied with the first voltage.

The second sub region electrode a2 which is disposed in one of the upper and the lower unit electrodes UP and DP may be substantially a bottom side and two oblique sides and the one bottom side may correspond to an edge of one pixel area.

Further, the second sub region electrodes a2 of the first subpixel electrodes 191a which are disposed in the upper unit electrode and the lower unit electrode ma be connected to each other and for example, may he connected through the first connecting unit 195a which extends along the edge of the pixel area.

The second sub region electrode a2 is connected to the first thin film transistor to be applied with a first voltage and shows a high gray scale.

The second subpixel electrode 191b includes an edge which is parallel to the edge of one pixel area and oblique sides corresponding to two oblique sides of the second sub region electrode a2 of the first subpixel electrode 191a. Accordingly, in the upper unit electrode or the lower unit electrode, the second subpixel electrode 191b and the second sub region electrode a2 of the first subpixel electrode 191a do not overlap in plan view and form a quadrangle in which a width and a height are similar to each other.

Further, the second subpixel electrodes 191b disposed in the upper unit electrode UP and the lower unit electrode DP may be electrically connected to each other through a second connecting unit 195b. For example, the second connecting unit 195b extends from an end of the second minute branch 194b of the second subpixel area a2 to connect the upper unit electrode UP and the unit electrode DP.

The second subpixel electrode 191b is connected to a second thin film transistor which is connected to a voltage dividing transistor to be applied with a second voltage which is lower than the first voltage.

In this case, a region where the second sub region electrode a2 is disposed is defined as a first part, a region where the first sub region electrode a1 and the second subpixel electrode 191b overlap is defined as a second part, and a region of the second subpixel electrode 191b which does not overlap the first sub region electrode a1 is defined as a third part.

Depending on the difference of a voltage which is applied to each pixel electrode and the common voltage, an electric field which is applied to the liquid crystal layer disposed in the first part R1 is the highest and an electric field which is applied to the liquid crystal layer disposed in the third part R3 is the lowest. Since the second part R2 is affected by the electric field by the first sub region electrode a1 of the first subpixel electrode 191a, the electric field which is applied to the liquid crystal layer disposed in the second part R2 is lower than the electric field which is applied to the liquid crystal layer disposed in the first part R1 and is higher than the electric field which is applied to the liquid crystal layer disposed in the third part R3.

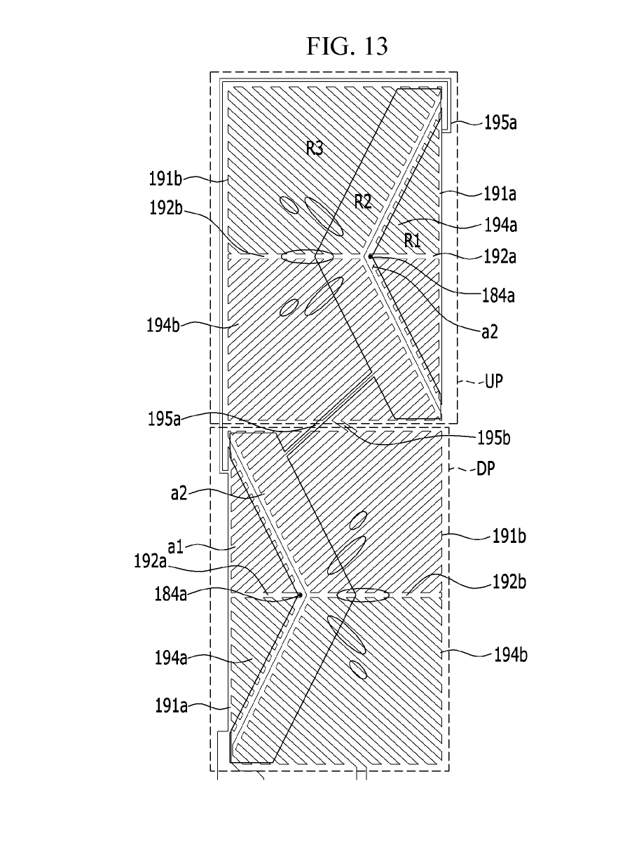

As described above, the display device according to the exemplary embodiment of the present invention divides one pixel region into the first pan R1 in which the first subpixel electrode 191a applied with a relatively high first voltage is disposed, a second part R2 in which the first subpixel electrode 191a and a second subpixel electrode 191b applied with as relatively low second voltage overlap with an insulating layer therebetween, and a third part R3 in which only the second subpixel electrode 191b applied with the relatively low second voltage is disposed, which will be described in more detail with reference to FIGS. 13 to 15.

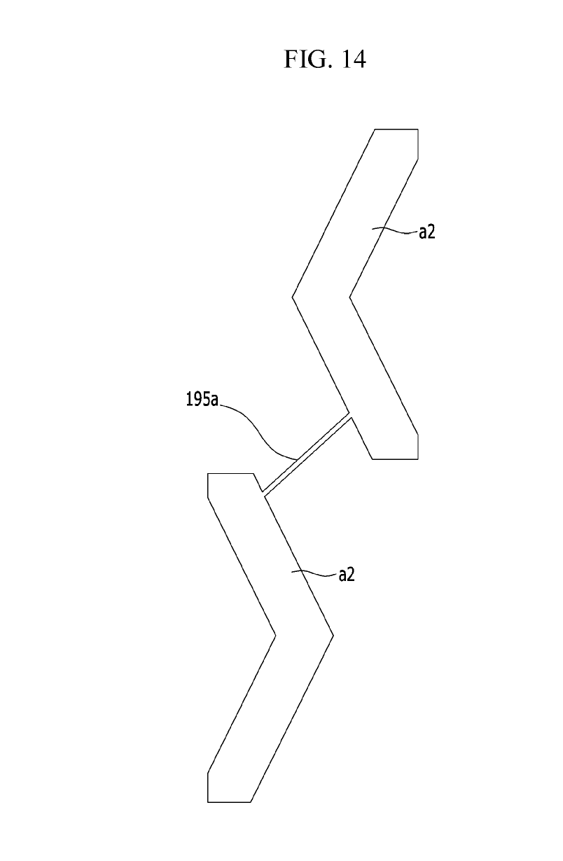

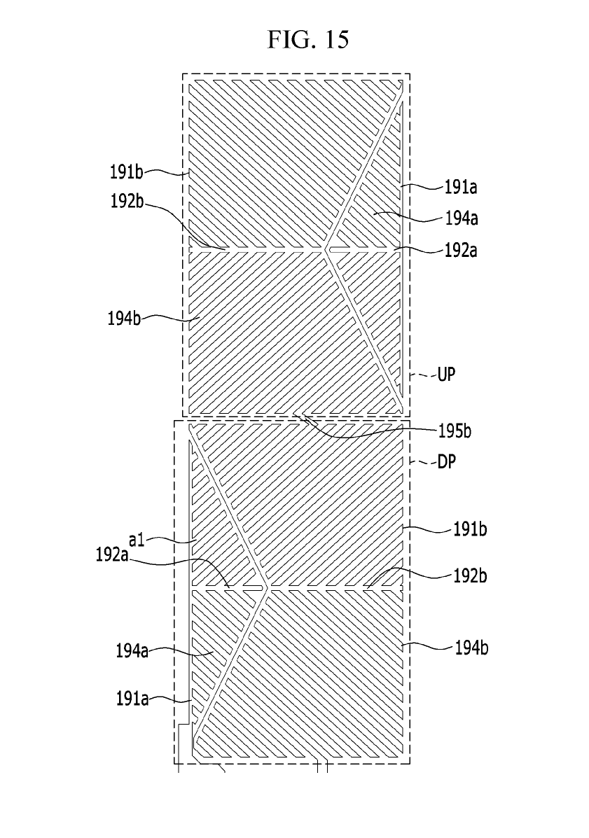

FIG. 13 is a top plan view of a basic pixel according to a comparative example of the present invention. FIG. 14 is a top plan view of a first sub region electrode a1 of a first subpixel electrode 191a according to a comparative example of the present invention and FIG. 15 is a top plan view of a second sub region electrode a2 of a first subpixel electrode 191a and a second subpixel electrode according to an exemplary embodiment of the present invention.

Referring to FIG. 13, one pixel area of a display device according to the comparative example includes a first subpixel electrode 191a and a second subpixel electrode 191b, includes an upper unit electrode unit electrode UP and a lower unit electrode DP which are distinguished by the location and also includes a first part R1, a second part R2, and a third part R3 which are distinguished by a level of applied electric field.

The first sub region electrodes a1 of the first subpixel electrode 191a which are disposed in the upper unit electrode UP and the lower unit electrode DP are disposed in a different layer from the second sub region electrode a2 of the first subpixel electrode 191a and for example, may be disposed in a different layer from the second sub region electrode a2 with an insulating layer therebetween.

The first sub region electrode a1 is connected to the second sub region electrode a2 through a contact hole and applied with the first data voltage which is applied to the second sub region electrode a2.

The first sub region electrode a1 may further include a first connecting unit 195a which connects the first sub region electrodes a1 which are disposed in the upper unit electrode and the lower unit electrode and a shape of the first connecting unit 195a is not specifically limited.

Accordingly, the upper unit electrode and the lower unit electrode include the first sub region electrodes a1, respectively, and the first sub region electrodes a1 disposed in the upper unit electrode and the lower unit electrode may have the same shape to be disposed in the corresponding position.

Further, second subpixel electrodes 191b which are disposed in the upper unit electrode and the lower unit electrode may he electrically connected to each other through the second connecting unit 195b. For example, the second connecting unit 195b extends from an end of the second minute branch 194b of the second subpixel area to connect the upper unit electrode and the lower unit electrode.

Next, the first part R1, the second part R2, and t he third part R3 which are divided depending on the level of the applied electric field will be described.

First, in the first part R1, the second sub region electrode a2 of the first subpixel electrode 191a disposed in the lower panel and the common electrode 270 disposed in the upper panel 200 generate an electric field. In this case, the voltage which is applied to the second sub region electrode a2 is the highest among the voltages which are applied to one pixel area so that a region where the electric field is high is formed together with the common electrode 270.

Next, in the second part R2, the first sub region electrode a1 of the first subpixel electrode 191a and the second subpixel electrode 191b overlap. The liquid crystal molecules 31 of the liquid crystal layer 3 are arranged by the electric field generated between the first sub region electrode a1 and the common electrode of the upper panel and the electric field generated between the second minute branch of the second subpixel electrode 191b and the common electrode. In this case, in the second part R2, since influence of the electric field by the first sub region electrode a1 of the first subpixel electrode 191a and influence of the electric field by the second subpixel electrode 191b coexist, a level of the electric field which is applied to the liquid crystal layer disposed in the second part R2 is lower than the electric field which is applied to the liquid crystal layer disposed in the first part R1 and is higher than the electric field which is applied to the liquid crystal layer disposed in the third part R3.

In the third part R3, the second subpixel electrode 191b of the lower panel 100 and the common electrode of the upper panel 200 generate an electric field. In this case, the voltage which is applied to the second subpixel electrode 191b is a second voltage which is applied through a second switching element and is lower than the first voltage due to the voltage dividing transistor. Accordingly, the electric field generated between the second subpixel electrode 191b and the common electrode is lower than the electric field generated between the second sub region electrode a2 of the first subpixel electrode 191a and the common electrode.

Accordingly, the electric field which is applied to the liquid crystal layer disposed in the first part R1 is the highest and the electric field which is applied to the liquid crystal layer disposed in the third part R3 is the lowest. Since the second part R2 is affected by the electric field by the first sub region electrode a1 of the first subpixel electrode 191a, the electric field which is applied to the liquid crystal layer disposed in the second part R2 is lower than the electric field which is applied to the liquid crystal layer disposed in the first part R1 and is higher than the electric field which is applied to the liquid crystal layer disposed in the third part R3.

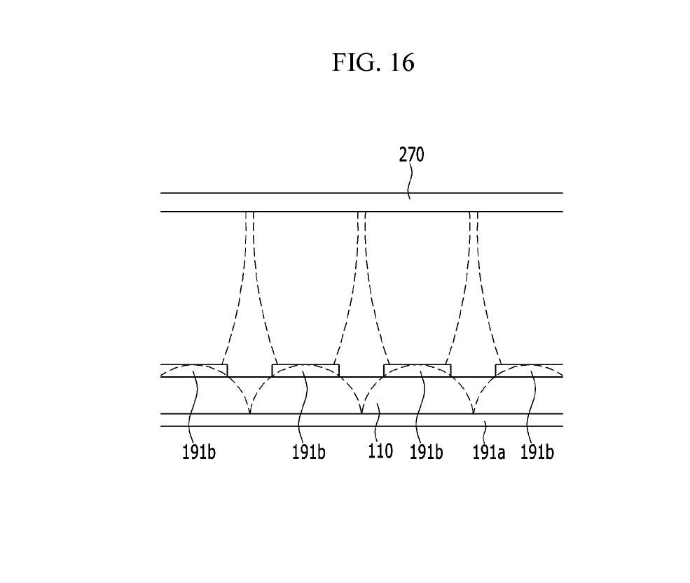

FIG. 16 illustrates an electric field formed in a second part R2 of a liquid crystal display according to a comparative example of the present invention. Referring to FIG. 16, in the second part, an electric field is generated between a first subpixel electrode to which a first data voltage is transmitted and a second subpixel electrode to which a second data voltage is transmitted and an electric field is generated between the second subpixel electrode and the common electrode 270 so that as a whole, a voltage which is different from the first data voltage and the second data voltage is generated.

As described above, also in the liquid crystal display according to the comparative example of the present invention, the pixel electrode is divided into three regions depending on the level of the electric field which is applied to the liquid crystal layer. However, in the liquid crystal display according to the comparative example of the present invention, since the part of the first subpixel electrode is disposed on another layer, the process may be complex.

However, in the display device according to the exemplary embodiment of the present invention, a region where the first subpixel electrode, and the second subpixel electrode coexist on the same layer is formed so that the pixel electrode is divided into three regions without dividing separate layers, thereby improving the visibility.

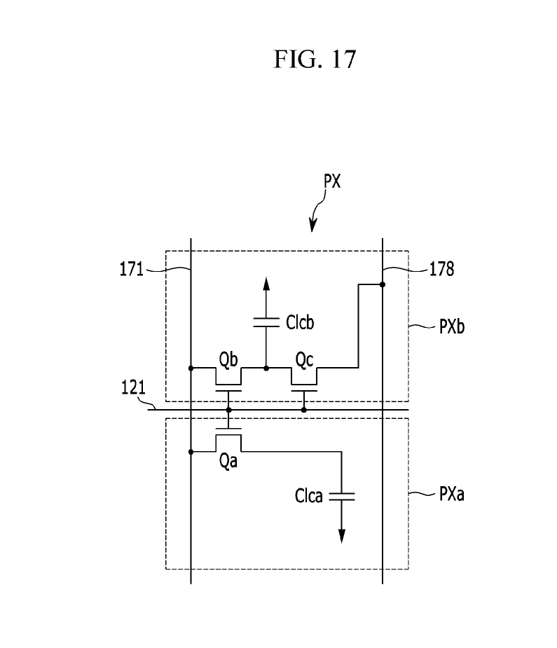

Hereinafter, a driving method of the liquid crystal display according to an exemplary embodiment of the present invention will be described with reference to FIGS. 17 to 21. FIGS. 17 to 21 are equivalent circuit diagrams of one pixel of a liquid crystal display according to an exemplary embodiment of the present invention.

Referring to FIG. 17, one pixel PX of a liquid crystal display according to an exemplary embodiment of the present exemplary embodiment includes a plurality of signal lines including a gate line GL which transmits a gate signal, a data line DL which transmits a data signal, and a voltage dividing reference voltage line RL which transmits a voltage dividing reference voltage, first, second and third switching elements Qa, Qb, Qc which are connected to the plurality of signal lines, and first and second liquid crystal capacitors Clca and Clcb.

The first and second switching elements Qa and Qb are connected to the gate line GL and the data line DL, respectively and the third switching element Qc is connected to an output terminal of the second switching element Qb and the voltage dividing reference voltage line RL.

The first switching element Qa and the second switching element Qb are three terminal elements such as a thin film transistor and a control terminal thereof is connected to the gate line GL, an input terminal is connected to the data line DL, and an output terminal of the first switching element Qa is connected to the first liquid crystal capacitor Clca, an output terminal of the second switching element Qb is connected to the second liquid crystal capacitor Clcb and an input terminal of the third switching element Qc.

The third switching element Qc is also a three terminal element such as a thin film transistor and a control terminal thereof is connected to the gate line GL, an input terminal is connected to the second liquid crystal capacitor Clcb, and an output terminal is connected to the voltage dividing reference voltage line RL.

When a gate on signal is applied, to the gate line GL, the first switching element Qa, the second switching element Qb, and the third switching element Qc which are connected thereto are turned on. Therefore, a data voltage which is applied to the data line DL is applied to the first subpixel electrode PEa and the second subpixel electrode PEb through the first switching element Qa and the second switching element Qb which are turned on. In this case, the data voltages which are applied to the first subpixel electrode PEa and the second subpixel electrode PEb are equal to each other and the first liquid crystal capacitor Clca and the second liquid crystal capacitor Clcb are charged with a voltage which is equal to a difference between the common voltage and the data voltage. Simultaneously, the voltage which is charged into the second liquid crystal capacitor Clcb is divided by the third switching element Qc which is turned on. By doing this, the voltage which is charged into the second liquid crystal capacitor Clcb is lowered due to the difference between the common voltage and the voltage dividing reference voltage. That is, the voltage which is charged into the first liquid crystal capacitor Clca is higher than the voltage which is charged into the second liquid crystal capacitor Clcb.

As described above, the voltage which is charged into the first liquid crystal capacitor Clca is different from the voltage which is charged into the second liquid crystal capacitor Clcb. Since the voltage of the first liquid crystal capacitor Clca is different from the voltage of the second liquid crystal capacitor Clcb, angles of inclined liquid crystal molecules in the first subpixel and the second subpixel are different from each other, so that luminances of two pixels are different from each other. Accordingly, when the voltage of the first liquid crystal capacitor Clca and the voltage of the second liquid crystal capacitor Clcb are appropriately adjusted, an image which is seen from the side is closer to an image which is seen from the front as much as possible, thereby improving a side visibility.

In the illustrated exemplary embodiment, in order to make the voltage which is charged into the first liquid crystal capacitor Clca be different from the voltage which is charged into the second liquid crystal capacitor Clcb, the third switching element Qc which is connected to the second liquid crystal capacitor Clcb and the voltage dividing reference voltage line RL, is provided. However, in the liquid crystal display according to another exemplary embodiment of the present invention, the second liquid crystal capacitor Clcb may be connected to a step-down capacitor. Specifically, the third switching element including a first terminal which is connected to a step down gate line, a second terminal which is connected to the second liquid crystal capacitor Clcb, and a third terminal which is connected to the step down capacitor is provided so that a part of a quantity of charges charged into the second liquid crystal capacitor Clcb is charged into the step-down capacitor, thereby setting charged voltages between the first liquid crystal capacitor Clca and the second liquid crystal capacitor Clcb to be different from each other. Further, in the case of the liquid crystal display according to another exemplary embodiment of the present invention, the first liquid crystal capacitor Clca and the second liquid crystal capacitor Clcb are connected to different data lines to be applied with different data voltages, thereby setting charged voltages between the first liquid crystal capacitor Clca and the second liquid crystal capacitor Clcb to be different from each other. In addition, the charged voltage between the first liquid crystal capacitor Clca and the second liquid crystal capacitor Clcb may be set to be different from each other using various methods.

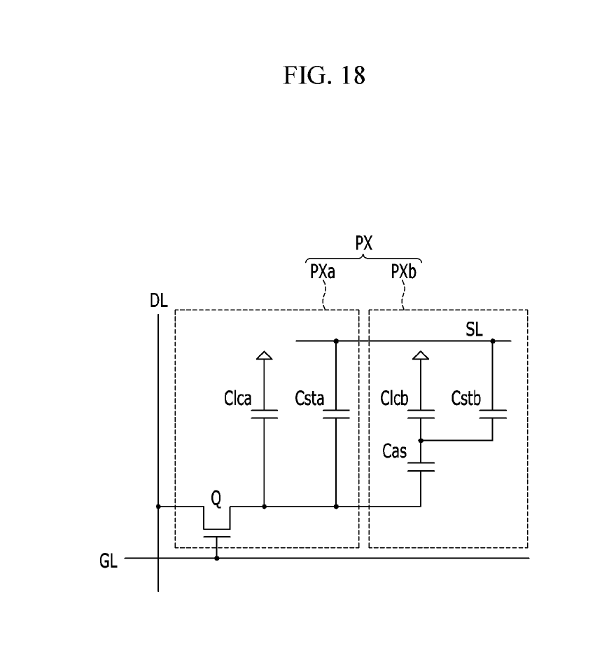

Next, an exemplary embodiment of FIG. 18 will be described.

A liquid crystal display according to an exemplary embodiment of the present invention includes a signal line including a plurality of gate lines GL, a plurality of data lines DL, and a plurality of storage electrode lines SL and a plurality of pixels PX connected thereto. Each pixel PX includes a pair of first and second subpixels PXa and PXb and a first subpixel electrode is formed in the first subpixel PXa and a second subpixel electrode is formed in the second subpixel PXb.

The liquid crystal display according to an exemplary embodiment of the present invention further includes a switching element Q connected to the gate line GL and the data line DL, a first liquid crystal capacitor Clca connected to the switching element Q to be formed in a first subpixel PXa, a second liquid crystal capacitor Clcb connected to the first storage capacitor Csta and the switching element Q to be formed in a second subpixel PXb, and an auxiliary capacitor Cas which is formed between the switching element Q and the second liquid crystal capacitor Clcb.

The switching clement Q is a three terminal element such as a thin film transistor which is provided in the lower panel 100 and a control terminal is connected to the gate line GL, an input terminal is connected to the data line DL, and an output terminal is connected to the first liquid crystal capacitor Clca, the first storage capacitor Csta, and the auxiliary capacitor Cas.

One terminal of the auxiliary capacitor Cas is connected to the output terminal of the switching element Q and the other terminal is connected to the second liquid crystal capacitor Clcb and the second storage capacitor Cstb.

The charged voltage of the second liquid crystal capacitor Clcb is lower than the charged voltage of the first liquid crystal capacitor Clca due to the auxiliary capacitor Cas, thereby improving the side visibility of the liquid crystal display.

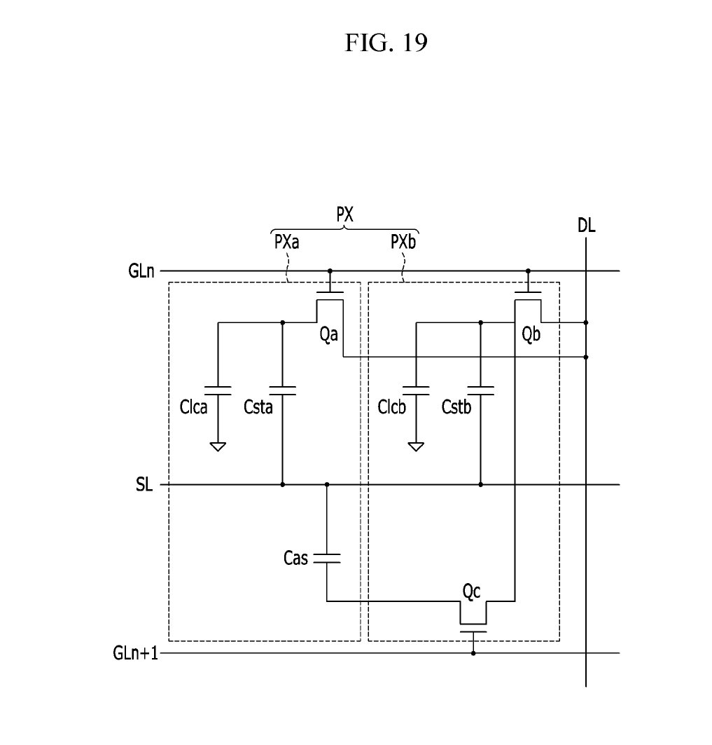

Hereinafter, an exemplary embodiment of FIG. 19 will be described.

A liquid crystal display according to an exemplary embodiment of the present invention includes a signal line including a plurality of gate lines GLn and GLn+1, a plurality of data lines DL, and a plurality of storage electrode lines SL and a plurality of pixels PX connected thereto. Each pixel PX includes a pair of first and second subpixels PXa and PXb and a first subpixel electrode is formed in the first subpixel PXa and a second subpixel electrode is formed in the second subpixel PXb.

The liquid crystal display according to an exemplary embodiment of the present invention further includes a first switching element Qa and a second switching element Qb connected to the gate line GLn and the data line DL, a first liquid crystal capacitor Clca connected to the first switching element Qa to be formed in a first subpixel PX, a second liquid crystal capacitor Clcb connected to the first storage capacitor Csta and the second switching element Qb to be formed in a second subpixel PXb, a third switching element Qc which is connected to the second switching element Qc and is switched by the gate line GLn+1 in the next stage, and an auxiliary capacitor Cas which is connected to the third switching element Qc.

The first switching element Qa and the second switching element Qb are three terminal elements such as thin film transistors which are provided in the lower panel 100 and control terminals are connected to the gate line GLn, input terminals are connected to the data line DL, and output terminals are connected to the first liquid crystal capacitor Clca and the first storage capacitor Csta, and the second liquid crystal capacitor Clcb and the second storage capacitor Cstb, respectively.

The third switching element Qc is also a three terminal element such as a thin film transistor which is provided in the lower panel 100 and a control terminal is connected to the gate line GLn+1 of the next stage, an input terminal is connected to the second liquid crystal capacitor Clcb, and an output terminal is connected to the auxiliary capacitor Cas.

One terminal of the auxiliary capacitor Cas is connected to the output terminal of the third switching element Qc and the other terminal is connected to the storage capacitor SL.

An operation of the liquid crystal display according to the exemplary embodiment of the present invention will be described. When a gate-on voltage is applied to the gate line GLn, the first switching element and the second switching element Qa and Qb which are connected thereto are turned on, and the data voltage of the data line 171 is applied to the first and second subpixel electrodes.

Next, when a gate-off voltage is applied to the gate line GLn and a gate-on voltage is applied to the gate line GLn+1 of the next stage, the first and second switching elements Qa and Qb are turned off and the third switching element Qc is turned on. Therefore, charges of the second subpixel electrode which is connected to the output terminal of the second switching element Qb flows into the auxiliary capacitor Cas so that the voltage of the second liquid crystal capacitor Clcb is lowered.

As described above, the side visibility of the liquid crystal display may be improved by making the charged voltages of the first and second liquid crystal capacitors Clca and Clcb be different from each other.

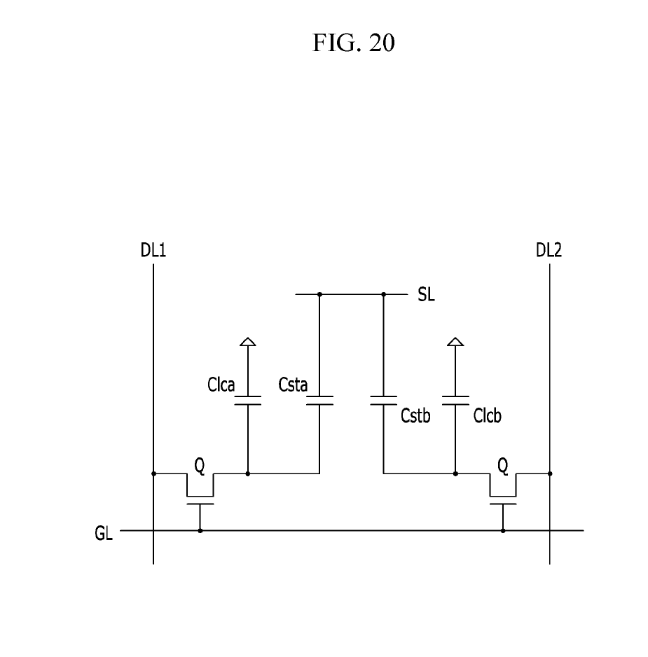

Next, an exemplary embodiment of FIG. 20 will be described.

A liquid crystal display according to an exemplary embodiment of the present invention includes a signal line including a plurality of gate lines GL, a plurality of data lines DL1 and DL2, and a plurality of storage electrode lines SL and a plurality of pixels PX connected thereto. Each pixel PX includes a pair of first and second liquid crystal capacitors Clca and Clcb and first and second storage capacitors Csta and Cstb.

Each subpixel includes one liquid crystal capacitor and one storage capacitor and further includes one thin film transistor Q. The thin transistors Q of two subpixels in one pixel are connected to the same gate line GL, but connected to different data lines DL1 and DL2. The different data lines DL1 and DL2 simultaneously apply different levels of data voltages so that the first and second liquid crystal capacitors Clca and Clcb of the two pixels have different charging voltages. As a result, the side visibility of the liquid crystal display may be improved.

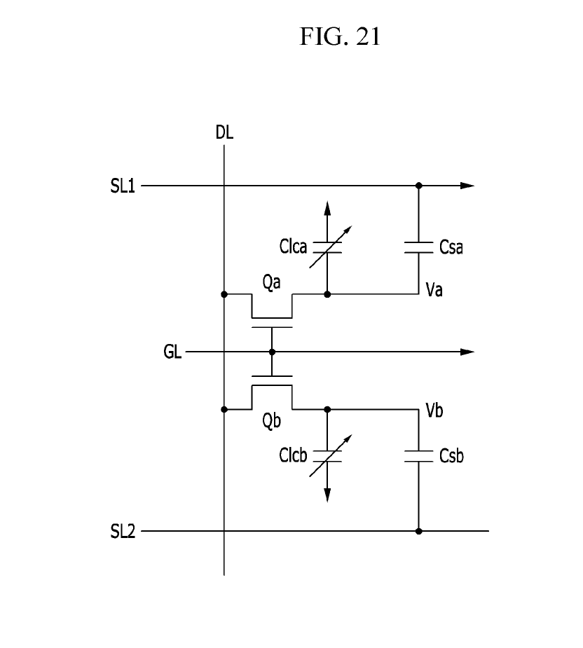

Hereinafter, an exemplary embodiment of FIG. 21 will be described.

As illustrated in FIG. 21, a liquid crystal display according to an exemplary embodiment of the present invention includes a gate line GL, a data line DL, a first power line SL1, a second power line SL2, and a first switching element Qa and a second switching element Qb which are connected to the gate line GL and the data line DL.

The liquid crystal display according to an exemplary embodiment of the present invention further includes an auxiliary step-up capacitor Csa which is connected to the first switching element Qa, a first liquid crystal capacitor Clca, an auxiliary step-down capacitor Csb which is connected to the second switching element Qb, and a second liquid crystal capacitor Clcb.

The first switching element Qa and the second switching element Qb are formed of three terminal elements such as thin film transistors. The first switching element Qa and the second switching element Qb are connected to the same gate line GL and the same data line DL to be turned on at the same timing, thereby outputting the same data signal.

A voltage which swings with a predetermined period is applied to the first power line SL1 and the second power line SL2. A first low voltage is applied to the first power line SL1 during a predetermined period (for example, 1H) and a first high voltage is applied thereto during a next predetermined period. A second high voltage is applied to the second power line SL2 during a predetermined period and a second low voltage is applied thereto during a next predetermined period. In this case, the first period and the second period are repeated plural times for one frame so that a swinging voltage is applied to the first power line SL1 and the second power line SL2. In this case, the first low voltage is equal to the second low voltage and the first high voltage is equal to the second high voltage.

The auxiliary step-up capacitor Csa is connected to the first switching element Qa and the first power line SL1 and the auxiliary step-down capacitor Csb is connected to the second switching element Qb and the second power line SL2.

A voltage Va of a terminal (hereinafter, referred to as a “first terminal”) in a portion where the auxiliary step-up capacitor Csa is connected to the first switching element Qa is lowered when the first low voltage is applied to the first power line SL1 and rises when the first high voltage is applied. Thereafter, the voltage Va of the first terminal swings as a voltage of the first power line SL1 swings.

While this invention has been described in connection with what is presently considered to he practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 100, 200: display panel | 121: gate line |
| 124: gate electrode | 131: reference voltage line |
| 140: gate insulating, layer | 154: semiconductor |
| 171: data line | 173: source electrode |
| 175: drain electrode | 180b: insulating layer |
| 185a, 185b: contact hole | 191: pixel electrode |
| 191a: first subpixel electrode | 191b: second subpixel electrode |
| 192a, 192b: vertical stem portion | 193a, 193b, 195a, 195b, 197a, 197b: |
| | horizontal stem portion |
| 194a, 194b, 196a, 196b, 198a, | 210: second insulation substrate |
| 198b: minute branch | |
| 220: light blocking member | 230: color filter |

What is claimed is:

1. A liquid crystal display, comprising:
a first substrate;
a gate line formed on the first substrate;
an insulating layer formed on the gate line; and
a pixel electrode formed on the insulating layer and including a first subpixel electrode and a second subpixel electrode;
wherein the pixel electrode is divided into first sub region, second sub region, and third sub region,
the first subpixel electrode is formed in the first sub region,
the second subpixel electrode is formed in the third sub region, and
both the first subpixel electrode and the second subpixel electrode are formed in the second sub region.

2. The liquid crystal display of claim 1, wherein the first subpixel electrode includes
a vertical stem portion,
a plurality of horizontal stem portions extending from the vertical stem portion, and
a first part, a second part, and a third part which are defined by the horizontal stem portions, and
the second subpixel electrode includes
a vertical stem portion,
a plurality of horizontal stem portions extending from the vertical stem portion, and
a first part, a second part, and a third part which are defined by the horizontal stem portions.

3. The liquid crystal display of claim 2, wherein the first part of the first subpixel electrode includes a horizontal stem portion disposed at a center and minute branches extending from the horizontal stem portion in both diagonal directions.

4. The liquid crystal display of claim 3, wherein the second part of the first subpixel electrode includes horizontal stem portions formed at an upper portion and a lower portion and minute branches extending from the horizontal stem portion to the center of the second part and
an interval of minute branches formed in the second part is larger than an interval of minute branches formed in the first part of the first subpixel electrode.

5. The liquid crystal display of claim 4, wherein the third part of the first subpixel electrode includes a horizontal stem portion disposed at a center and minute branches extending from the horizontal stem portion in both diagonal directions and
an interval of formed minute branches is larger than an interval of minute branches formed in the first part of the first subpixel electrode.

6. The liquid crystal display of claim 2, wherein the first part of the second subpixel electrode includes a horizontal stem portion disposed at a center and minute branches extending from the horizontal stem portion in both diagonal directions.

7. The liquid crystal display of claim 6, wherein the second part of the second subpixel electrode includes horizontal stem portions formed at an upper portion and a lower portion and minute branches extending from the horizontal stem portion to the center of the second part and
an interval of minute branches formed in the second part is larger than an interval of minute branches formed in the first part of the first subpixel electrode.

8. The liquid crystal display of claim 7, wherein the third part of the second subpixel electrode includes a horizontal stem portion disposed at a center and minute branches extending from the horizontal stem portion in both diagonal directions and
an interval of formed minute branches is larger than an interval of minute branches formed in the first part of the second subpixel electrode.

9. The liquid crystal display of claim 2, wherein
the first part of the first subpixel electrode configures the first sub region,
the first part of the second subpixel electrode configures the third sub region,
the second part of the first subpixel electrode and the third part of the second subpixel electrode share a space and are alternately formed to configure the second sub region, and
the third part of the first subpixel electrode and the second part of the second subpixel electrode share a space and are alternately formed to configure the second sub region.

10. The liquid crystal display of claim 1, wherein the first subpixel electrode and the second subpixel electrode are applied with different voltages and a voltage which is applied to the first subpixel electrode is higher than a voltage which is applied to the second subpixel electrode.

11. The liquid crystal display of claim 9, wherein the number of minute branches of the second part of the first subpixel electrode is different from the number of minute branches of the third part of the second subpixel electrode.

12. The liquid crystal display of claim 9, wherein the number of minute branches of the third part of the first subpixel electrode is different from the number of minute branches of the second part of the second subpixel electrode.

13. The liquid crystal display of claim 1, wherein
the highest electric field is formed in the first sub region,
the lowest electric field is formed in the third sub region, and
an electric field having an intermediate level between the electric field of the first sub region and the electric field of the third sub region is formed in the second sub region.

14. The liquid crystal display of claim 1, wherein each of the first subpixel electrode and the second subpixel electrode includes
a vertical stem portion,
a plurality of horizontal stem portions extending from the vertical stem portion, and
a plurality of minute branches extending from the plurality of horizontal stem portions,
the vertical stem portion of the first subpixel electrode and the vertical stem portion of the second subpixel electrode are formed to be opposite to each other along both edges of one pixel area.

15. The liquid crystal display of claim 14, wherein the plurality of minute branches are formed at +40 degrees to +50 degrees or −40 degrees to −50 degrees with respect to the horizontal stern portion.

16. The liquid crystal display of claim 9, wherein in the second sub region, one minute branch of the second subpixel electrode is formed to be alternated with two minute branches of the first subpixel electrode.

17. The liquid crystal display of claim 9, wherein in the second sub region, two minute branches of the second subpixel electrode are formed to be alternated with one minute branch of the first subpixel electrode.
